(19) United States
(12) Patent Application Publication
(10) Pub. No.: US 2024/0018631 A1
(43) Pub. Date: Jan. 18, 2024

(54) A HIGH TEMPERATURE STABLE ALSICU ALLOY

(71) Applicant: Norsk Hydro ASA, OSLO (NO)

(72) Inventors: Petter ÅSHOLT, SUNNDALSØRA (NO); Martha INDRIYATI, GRØA (NO)

(73) Assignee: Norsk Hydro ASA, OSLO (NO)

(21) Appl. No.: 18/039,545

(22) PCT Filed: Nov. 26, 2021
(86) PCT No.: PCT/EP2021/083106

§ 371 Date: May 31, 2023

(30) Foreign Application Priority Data
Dec. 7, 2020 (NO) 20201336

(51) Int. Cl. C22C 21/02; C22C 1/02

(52) U.S. Cl. CPC C22C 21/02; C22C 1/026

(57) ABSTRACT

The invention relates to a high temperature stability Al—Si—Cu casting alloy with an addition of Sn to improve ageing kinetics and mechanical properties. The alloy is suitable for gravity die casting and comprises 6 to 8 wt. % Si, 2 to 4 wt. % Cu, 0.03 to 0.09 wt. % Sn, 0.05 to 0.1 wt. % Ti, up to 0.2 wt. % Mn, up to 0.2 wt. % Fe, up to 0.03 wt. % Sr, grain refining element in the scale of 1 N kg/ton and unavoidable impurities up to 0.05 wt. %. The alloy may also contain one or more of the following elements: Mg max 0.25 wt. %, Zr max 0.2 wt. % and Hf max 0.5 wt. %. The addition of Sn leads to the finer and denser distribution of O′—Al2Cu precipitates, enhancing the mechanical properties and ageing kinetics of the alloy.

### TECHNICAL FIELD

The present invention relates to an Al—Si series alloys, and more particularly to a high temperature stability Al—Si—Cu cast aluminium alloy that has improved ageing response and mechanical properties due to trace addition of Sn. When utilised using gravity die casting, significantly faster ageing time and higher tensile properties were achieved. These observations were attributed to finer and denser θ′-Al2Cu precipitates achieved by the trace addition of Sn.

### BACKGROUND

Al—Si—Mg foundry alloys have been extensively used in automotive engine applications for decades due to their high strength and good castability. Their ability to get heat treated to control the morphology and distribution of precipitates enables them to be produced in a variety of microstructural conditions, leading to a wide range of strengths at room temperature. However, their poor thermal stability due to the coarsening and dissolution of β″-Mg2Si precipitates limits their application in internal combustion engines (ICE) which operate under severe temperature and stress. Hence, the ideal engine alloys should have good creep resistance (up to 250° C.) as well as tensile properties to prevent crack formation and catastrophic failures. Furthermore, it should also exhibit microstructural stability at engine's working temperature to prevent excessive over-ageing and property degradation.

In today's ICE's application, AlSi7Mg+0.5% Cu alloy is commonly used. The addition of 0.5 wt. % Cu to foundry alloys improves the creep resistance and strength of the alloy up to 250° C. due to the existence of Q′-Al5Mg8Cu2Si6 (or its precursors) and θ′-Al2Cu precipitates. However, its mechanical properties are rapidly degraded at temperatures above 250° C. Over decades, there have been several research initiatives conducted to improve high temperature stability properties of Al—Si based alloys. US9982328B2 discloses high hot creep and fatigue resistance of a cast Al alloy comprising (in wt. %) 3-11% Si, 2.0-5.0% Cu, 0.05-0.50% Mn, 0.10-0.25% Mg, <0.30% Zn, <0.30% Ni, 0.05-0.19% V, 0.05-0.25% Zr and 0.01-0.25% Ti. Moreover, US 2019/016971 6 A1 discloses high temperature stability alloy comprising (in wt. %) 3-12% Si, 0.5-2.0% Cu, 0.2-0.6% Mg, 0-0.5% Cr, 0-0.3% each of Zr, V, Co and Ba; 0-0.3% each of Sr, Ca and Ti; 0-0.5% each of Fe, Mn and Zn; and about 0.01% of other trace elements. All these inventions contain Mg as the alloying element to provide good mechanical properties at room temperature. A Mg-free alloy is however known from EP 1651787A1 which discloses heat resistant Al—Si—Cu alloy comprising (in wt. %) Mg 0.1; Si: 4.5-10; Cu: 2.0-5.0; Ni 0.4; Fe 0.9; Zn 0.3; Ti : 0.05-0.25; Zr : 0.05-0.25; V : 0.02-0.3; Mn : 0.1-0.5; Hf, Nb, Ta, Cr, Mo and/or W : 0.03-0.3; other elements 0.1 each and 0.30 in total. Although good elevated temperature properties and creep strength was obtained, an alloy with improved ageing time and higher tensile strength is still to be developed.

### BRIEF DESCRIPTION OF THE DRAWINGS

The invention will now be described in more detail with reference to the accompanying figures.

FIG. 1 shows the room temperature tensile properties of an AlSi7 alloy with a variation of the Cu content showing increasing tensile strength and decreasing ductility with increasing Cu content.

FIG. 2 shows ageing curves of an AlSi7 alloy with a variation of the Cu content following solution heat treatment (SHT) at 515° C. for 8 hours+WQ+AA at 200° C. showing no significant age hardening potential with addition of Cu<1wt. %

FIG. 3 shows the Al—Si7—Cu binary phase diagram showing the maximum solubility limit of Cu in the Al—Si7—Cu alloy according to the invention

FIG. 4 shows the hardness profiles of the alloy in example 1 after ageing at 200° C.

FIG. 5 shows TEM investigation of AlSi7Cu3.5 alloy with and without addition of Sn showing finer and denser θ′-Al2Cu precipitates in Sn containing alloy

FIG. 6 shows the room temperature tensile properties of all alloy variants studied in example 2

FIG. 7 shows tensile properties of the alloys of example 2 following exposure at 250° C. for 500 hours

FIG. 8 shows the room temperature yield strength vs the uniform elongation of the alloy variants (five samples per each alloy) in Example 3 compared to Ref alloy (AlSi7MgCu0.5)

FIG. 9 shows the yield strength vs uniform elongation of alloy variants (five samples per each alloy) in Example 3 compared to Ref alloy (AlSi7MgCu0.5) after exposure at 250° C. for 500 hours

### SUMMARY OF THE INVENTION

The present invention provides high temperature stability cast aluminium alloys, an Al—Si—Cu base alloy with or without low addition of Mg, which have significantly improved ageing kinetics and room temperature mechanical properties due to trace addition of Sn. The faster ageing kinetics and hence faster ageing time achieved by the present alloys gives an advantage on reducing its production cost. Furthermore, the copper bearing alloys lead to better thermal stability than conventional AlSi7Mg due to the presence of θ′-Al2Cu precipitates being stable to higher temperature than β″-Mg2Si precipitates. This is assumedly also the case for Q′-Al5Mg8Cu2Si6 precipitates (or its precursors) in alloys with a small Mg addition.

The aluminium alloy according to the invention comprises:

An aluminium alloy, comprising:

Mg: <0.25 wt. %, preferably 0.01-0.2 wt. %;

### Si: 6-8 wt. %;

### Cu: 2-4 wt. %;

Mn: <0.2 wt. %, preferably 0.01-0.1; more preferably 0.02-0.05 wt. %;

### Fe: <0.2 wt. %;

### Ti: 0.05-0.1 wt. %

### Zn: <1 wt. %

Sn: 0.03-0.09, preferably 0.04-0.08 wt. %
Sr: <0.03 wt. %, preferably 0.001-0.03 wt. %,

### Zr: <0.2 wt. %

### Hf: <0.5 wt. %

### Cr: <0.3 wt. %

### Mo: <0.3 wt. %

### V: <0.3 wt. %

### W: <0.3 wt. %

### Nb: <0.3 wt. %,

the balance being aluminium and up to 0.05 wt. % unavoidable impurities.

Adding Si to Al alloys has been known to increase fluidity of the Al alloy during casting and reduces hot cracking tendency. The Al alloy according to the invention contains Si in the range of 6-8 wt. % to provide necessary castability during gravity die casting for manufacturing part with geometrical complexity.

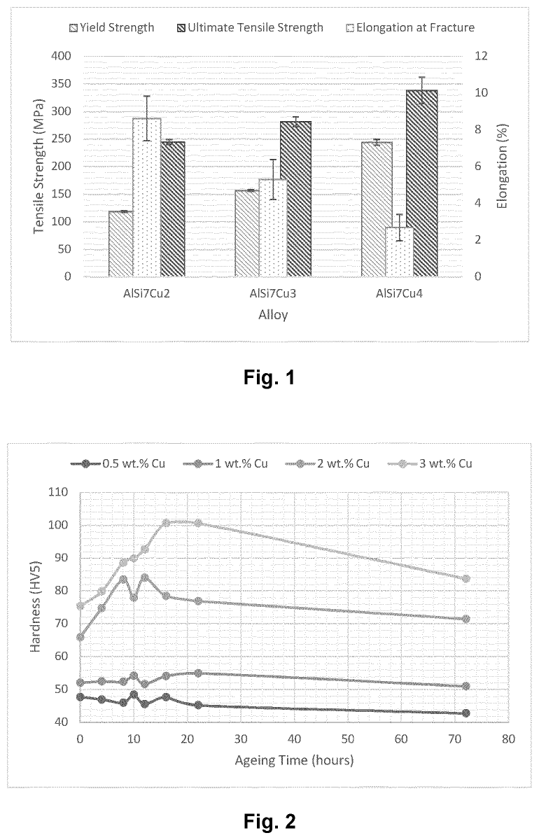

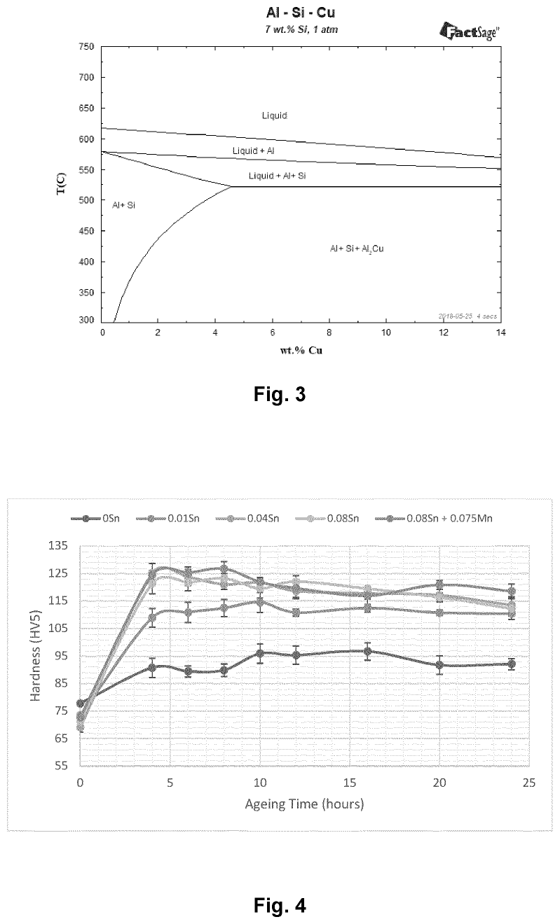

In addition, the Al alloy according to the invention also contains Cu to improve high temperature stability due to the formation of θ′-Al2Cu precipitates which are more stable to high temperature than β″-Mg2Si precipitates. Higher tensile strength (yield strength and UTS) was observed with increasing Cu content while ductility decreased (FIG. 1). Furthermore, no significant improvement on the age hardenability was observed by addition of Cu <1 wt. % (FIG. 2). Addition of Cu beyond its solubility limit in Al—Si alloy (˜4.3 wt. % at ±525° C. in AlSi7 alloy—FIG. 3) is expected to reduce its mechanical properties, especially ductility. By considering these aspects, the Cu content in the Al alloy according to the invention is kept within the range of 2-4 wt. %.

Sn increases tensile strength of AlSi7Cu alloys at room temperature as well as provides a faster ageing response due to finer distribution of θ′-Al2Cu precipitates. The addition of Sn is kept below its maximum solubility in Al (˜0.1 wt. % at ±600° C.). An addition of 0.03-0.09 wt. % Sn is preferred as it gives optimum mechanical properties. No significant improvement in mechanical properties was observed by addition of Sn below 0.03 wt. % and above 0.09 wt. % of Sn.

Furthermore, the alloy according to the invention may contain Mg for additional strength at room temperature. However, Mg is restricted to <0.25 wt. % since at higher content a coarsening of Mg containing precipitates takes place and the effect on the temperature stability is degraded. Moreover, the solubility of Sn seems to be reduced when Mg is added. More β-Sn particles were observed in the as cast structure at higher Mg content. These particles were unable to dissolve during solution treatment and will thus decrease the available β-Sn precipitates for nucleation of θ′-Al2Cu precipitates. Additions above 0.25 wt % will therefore not give significant enhancement in mechanical properties. The content of Mg is preferably 0.01-0.2 wt. %.

The Fe content in the Al alloy according to the invention is kept below 0.2 wt. % as higher contents will induce the formation of detrimental p-A15FeSi intermetallics, decreasing the ductility of the alloy.

Addition of Mn to the Al alloy has been known to transform detrimental needle shape β-Al5FeSi intermetallic into less detrimental Chinese script a-A115(Fe,Mn)3Si intermetallic. Moreover, the addition of Mn also results in an increase of total amount of (Fe+Mn) containing intermetallic compound. Hence, the addition of Mn should be limited to only the amount necessary to convert the β-A15FeSi phases. Addition of Mn also increases high temperature stability of the material as Mn reduces diffusion kinetics of Cu, slowing down the coarsening of θ′-Al2Cu precipitates. Therefore, it can retain its strength following long exposure at high temperature, providing more durable products.

The content of Mn should be <0.2 wt. %, preferably 0.01-0.1; more preferably 0.02-0.05 wt. %;

Sr refines Si eutectic and hence improves the mechanical properties of the alloy. Moreover, Sr additions result in the segregation of Al2Cu phase in the area away from Si eutectic which leads to the formation of large area of inter-dendritic blocky Al2Cu phase. These particles need a longer time to be dissolved during solution treatment and hence could decrease Cu in solid solution required for precipitation. Consequently, addition of Sr should be limited to <0.03 wt%, preferably the content of Sr is 0.001-0.03, more preferably 0.005-0.03 wt. %, preferably 50 ppm-150 ppm

Moreover, the alloy according to the invention may also contain Zr and/or Hf in the level of <0.2 wt. % or <0.5 wt. % respectively to further increase the creep resistance of the alloy. Preferably the content of Zr is 0.02-0.2 wt. % and/or the content of Hf is 0.02-0.5 wt. %.

The invention also relates to an aluminium casting made from the aluminium alloy and a method for producing the aluminium casting according to claim 5, comprising the steps

Gravity die casting, preferably at 700-750° C.

Degassing to remove hydrogen in the melt
Adding grain refiner, preferably at the range of 0.5-2kg/ton
Solution heat treatment preferably at 490° C.-515° C. for 1-10 hours
Water quench

Ageing, preferably at 180° C.-240° C., for 2-8 hours, preferably for 4-5 hours

The invention provides improved durability under service condition for internal combustion engine (ICE) parts, i.e. cylinder heads.

### DETAILED DESCRIPTION

Aluminium alloys are provided having an enhancement in age hardenability as well as high temperature properties for ICE applications. The Al alloys were prepared by gravity casting using a permanent mould. Commercial alloy AlSi7MgCu0.5 is also included as a reference alloy. The castings were made by adding each alloying elements with appropriate ratio and melting them in a 40 kg electric resistance furnace. Mechanical stirring was performed during each alloying element addition to ensure the dissolution of the alloying elements and homogenisation of the melt. When the melt was fully homogenised, degassing was conducted with rotor impeller (rotor speed: 200 rpm) using argon gas for 20 minutes. Sr in the form of Al-10 wt. % Sr master alloy was added after degassing. Similarly, TiB2 grain refiner in the formed of Al—3Ti—B was added in the amount of 1 kg/ton before casting/pouring. The melt was then cast at 730° C. in a permanent steel mould which was coated with boron nitride and pre-heated to 315° C. prior to casting.

### EXAMPLE 1. The Influence of Sn on Age Hardening

Four alloys with a composition listed in Table 1 were cast into a permanent mould as described above to investigate the influence of Sn addition on the age hardening. Following casting, the samples were solution heat treated (SHT) at 515° C. for 8 hours followed by immediate water quenching (WQ) upon removal from the furnace. Artificial ageing (AA) at 200° C. was carried out at several different ageing times. Age hardening behaviour was characterised using Vickers hardness measurement with a load of 5 kg and a load time of 30 s. An average of 5 indentations was calculated to give the final hardness result (see FIG. 2). TEM investigation was carried out using JEOL JEM 2100 (LaB6) to identify the precipitated phases. The TEM sample was electropolished and ion milled prior to the investigation and bright field was utilised during imaging.

TABLE 1

| | | | | | | | | | |
|---|---|---|---|---|---|---|---|---|---|
| Alloy | | | | | | | | | |
| Designation | Si | Mg | Cu | Sn | Mn | Fe | Sr | Ti | Al |

| | | | | | | | | |
|---|---|---|---|---|---|---|---|---|
| 0Sn | 7.0 | 3.5 | | | 0.12 | 0.015 | 0.08 | Rem |
| 0.01Sn | 7.0 | 3.5 | 0.01 | | 0.12 | 0.015 | 0.08 | Rem |
| 0.04Sn | 7.0 | 3.5 | 0.04 | | 0.12 | 0.015 | 0.08 | Rem |
| 0.08Sn | 7.0 | 3.5 | 0.08 | | 0.12 | 0.015 | 0.08 | Rem |
| 0.08Sn + | 7.0 | 3.5 | 0.08 | 0.075 | 0.12 | 0.015 | 0.08 | Rem |
| 0.075Mn | | | | | | | | |

FIG. 4 shows ageing curves of the alloys listed in Table 1. Hardness was significantly increased by addition of Sn as well as Sn+Mn and hardness increased with increasing Sn content. Up to 31% raise in hardness was achieved with addition of Sn up to 0.08 wt. % in AlSi7Cu3.5 alloy. No further improvement in hardness was observed by addition of 0.075 wt. % Mn to Sn containing AlSi7Cu3.5 alloy.

In addition to the enhancement in hardness, addition of Sn to AlSi7Cu3.5 alloy also accelerated its ageing kinetics. Peak hardness was achieved after around 4-6 hours of ageing at 200° C. in the alloy containing >0.04 wt. % Sn, whilst in the alloy without Sn, peak hardness was reached after 10 hours ageing at 200° C. Fairly stable or slightly decreasing hardness was observed with further prolonged ageing time (up to 24 hours).

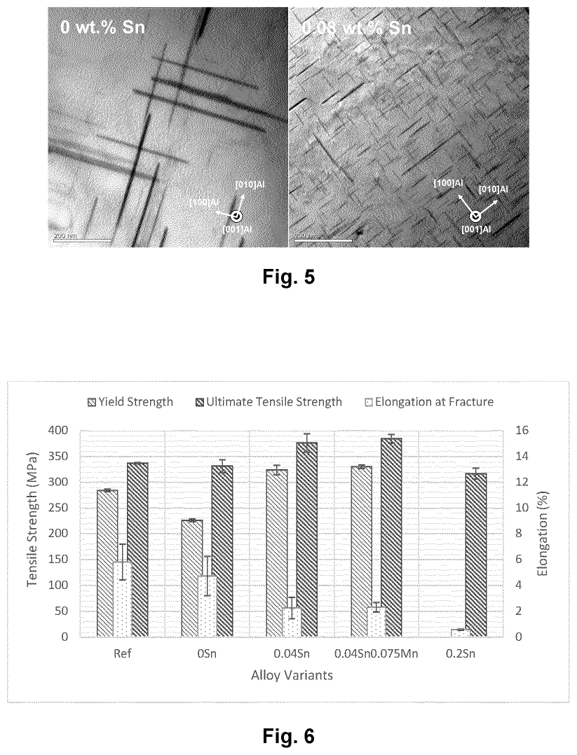

The enhancement of age hardening potential as well as ageing kinetics in Sn containing alloy observed above is due to the finer and denser θ′-Al2Cu precipitate structure as revealed in the TEM-pictures in FIG. 5. The addition of Sn assumedly leads to the formation of Sn clusters which further developed into β-Sn precipitates. These β-Sn precipitates act as a nucleation site for θ′-Al2Cu precipitates upon ageing, resulting in finer and denser precipitates.

### EXAMPLe 2. Influence of Sn and Mn on the Mechanical Properties

From the study in Example 1, five alloys including commercial alloy, AlSi7MgCu0.5 alloy (Ref), listed in Table 2 were cast into a permanent mould as described in example 1 and the samples exposed to tensile properties testing. An alloy with Sn composition higher than its solubility limit in Al alloy, 0.2 wt. % Sn, was also cast for a comparison. Uniaxial tensile testing was performed using Zwick Rowell tensile testing machine with 100 kN load capacity, a crosshead speed of 5 mm/min (elastic deformation), 10 mm/min (uniform plastic deformation) and 3 mm/min (after uniform plastic deformation). The test was carried out at ambient temperature. Prior to the tensile test, T7 temper according to Example 1 study (solution heat treatment 515° C. 8 hours +Water Quench+artificial ageing at 200° C. for 8 hours) was applied to AlSi7Cu3.5 base alloys, whilst commercial AlSi7MgCu0.5 alloy was heat treated as per established standard heat treatment for AlSi7MgCu0.5 (SHT 525° C. 10 hours+WQ+AA 200° C. 5 hours).

TABLE 2

| Alloy | | | | | | | | | |
|---|---|---|---|---|---|---|---|---|---|
| Designation | Si | Mg | Cu | Sn | Mn | Fe | Sr | Ti | Al |
| *Ref | 6.5- | 0.37- | 0.48- | | 0.05- | 0.15 | 0.018- | 0.10- | Rem |
| (AlSi7MgCu0.5) | 7.5 | 0.45 | 0.55 | | 0.1 | max | 0.028 | 0.15 | |
| 0Sn | 7 | | 3.5 | | | 0.12 | 0.015 | 0.08 | Rem |
| 0.04Sn | 7 | | 3.5 | 0.04 | | 0.12 | 0.015 | 0.08 | Rem |
| 0.04Sn + | 7 | | 3.5 | 0.04 | 0.075 | 0.12 | 0.015 | 0.08 | Rem |
| 0.075MN | | | | | | | | | |
| Ref* 0.02Sn | 7.0 | | 3.5 | 0.2 | | 0.12 | 0.015 | 0.08 | Rem |

Table 3 and FIG. 6 show room temperature tensile properties for all variants. It is clearly seen that the addition of Sn increases yield strength and tensile strength while elongation decreases. The increase in strength is attributed to the higher θ′′-Al2Cu precipitate density observed in FIG. 5. Yield strength increased around 40% by addition of 0.04 wt. % Sn to AlSi7Cu3.5 alloy. Compared to the Ref alloy AlSi7MgCu0.5, around 14% increase in yield strength was achieved. Adding Sn beyond its solubility in Al lead to brittleness. Adding Mn to the AlSi7Cu3.5Sn0.04 alloy gave an insignificant increase in both yield strength and elongation. This is in accordance with hardness 5 measurements which showed no major improvement by adding Mn to Sn containing alloy.

TABLE 3

| Alloy Designation | Rp_{0.2} (MPa) | Rₘ (MPa) | Aₜ (%) |
|---|---|---|---|
| AlSi7Mg0.4Cu0.5 | 284 | 337 | 5.8 |
| 0Sn | 226 | 331 | 4.7 |
| 0.04Sn | 324 | 376 | 2.3 |
| 0.04Sn + 0.075Mn | 330 | 384 | 2.3 |
| 0.2Sn | — | 317 | 0.6 |

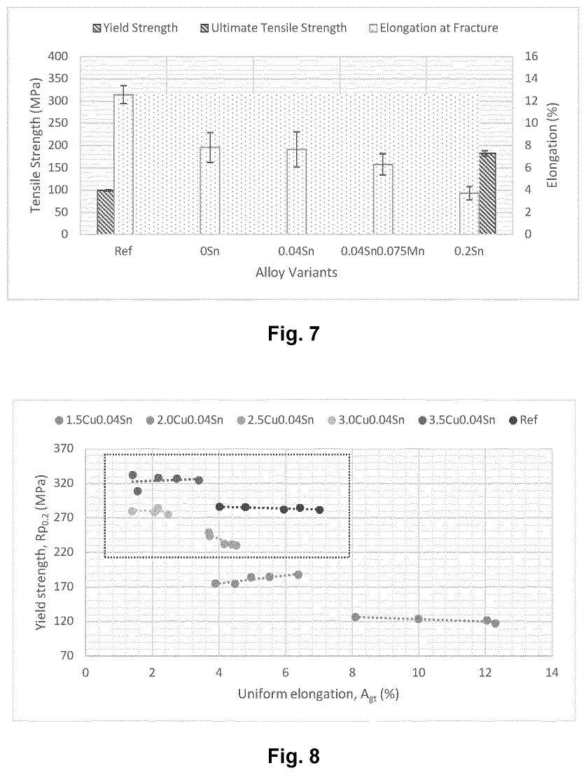

In addition to examination of tensile properties at room temperature, the strength durability of the alloys at elevated temperature was also explored. Prior to the test, the samples were subjected to a temperature of 250° C. for 500 hours followed by tensile testing at ambient temperature. The results of this durability test are shown in Table 4 and FIG. 7. No significant difference was observed in tensile properties by addition of 0.04 wt. % Sn to AlSi7Cu3.5 alloy, i.e the original significant positive effect of Sn on 15 strength has mostly vanished following exposure at 250° C. for 500 hours. However, compared to the Ref alloy AlSi7MgCu0.5, higher yield strength (±4% increment) and UTS (±17% increment) were observed. The elongation was, however, lower than the Ref alloy. Whilst addition of Mn to Sn containing alloy did not give significant influence on the room temperature properties, it improved tensile strength after exposure at high 20 temperature. This suggests that alloys containing Mn has better thermal stability.

Addition of Sn beyond its solubility in Al alloy again lead to a decrease in tensile properties, especially elongation. Furthermore, it is also noted that the difference between yield strength and UTS values in AlSi7Cu3.5Sn alloy was higher than for the Ref alloy, suggesting better work hardening potential.

TABLE 4

| Alloy Designation | Rp_{0.2} (MPa) | Rₘ (MPa) | Aₜ (%) |
|---|---|---|---|
| AlSi7Mg0.4Cu0.5 | 99 | 183 | 12.6 |
| 0Sn | 98 | 221 | 7.8 |
| 0.04Sn | 103 | 215 | 7.7 |
| 0.04Sn + 0.075Mn | 115 | 224 | 6.3 |
| 0.2Sn | 99 | 182 | 3.7 |

### EXAMPLE 3. Influence of Cu Level

Five alloys with a variation in Cu content (Table 5) were cast into a permanent mould with the same method as described in example 1 to investigate the effect of Cu content in Sn containing alloy on its mechanical properties. Uniaxial tensile testing was performed with the method mentioned in Example 2. Prior to the test, T7 temper (SHT 515° C. for 8 hours+WQ+AA200° C. for 8 hours) was applied to all alloy variants.

TABLE 5

| Alloy | | | | | | | | | |
|---|---|---|---|---|---|---|---|---|---|
| Designation | Si | Mg | Cu | Sn | Mn | Fe | Sr | Ti | Al |
| 1.5Cu0.04Sn | 7 | — | 1.5 | 0.04 | — | 0.12 | 0.015 | 0.08 | Rem |
| 2.0Cu0.04Sn | 7 | — | 2.0 | 0.04 | — | 0.12 | 0.015 | 0.08 | Rem |
| 2.5Cu0.04Sn | 7 | — | 2.5 | 0.04 | | 0.12 | 0.015 | 0.08 | Rem |
| 3.0Cu0.04Sn | 7 | — | 3.0 | 0.04 | — | 0.12 | 0.015 | 0.08 | Rem |
| 3.5Cu0.04Sn | 7.0 | — | 3.5 | 0.04 | | 0.12 | 0.015 | 0.08 | Rem |

Table 6 shows room temperature tensile properties of all alloy variants. It is clearly seen that increasing of Cu content led to the increasing yield strength and ultimate tensile strength. However, the ductility is decreasing with increasing Cu content. FIG. 8 shows tensile data (five parallels) of all alloy variants in Example 3 compared to commercial alloy AlSi7MgCu0.5 (Ref). A minimum of 2 wt. % Cu is needed to achieve comparable room temperature properties as the commercial alloy AlSi7MgCu0.5 (Ref) in T7 temper.

TABLE 6

| Alloy Designation | Rp_{0.2} (MPa) | Rₘ (MPa) | Aₜ (%) |
|---|---|---|---|
| AlSi7Mg0.4Cu0.5 | 284 | 337 | 5.8 |
| (Ref) | | | |
| 1.5Cu0.04Sn | 122 | 227 | 11.56 |
| 2.0Cu0.04Sn | 181 | 268 | 5.13 |
| 2.5Cu0.04Sn | 237 | 313 | 4.12 |
| 3.0Cu0.04Sn | 279 | 326 | 2.05 |
| 3.5Cu0.04Sn | 324 | 376 | 2.25 |

As in Example 2, tensile testing after temperature exposure was also performed. The result of this durability test after exposure at 250° C. for 500 hours is shown in Table 7.

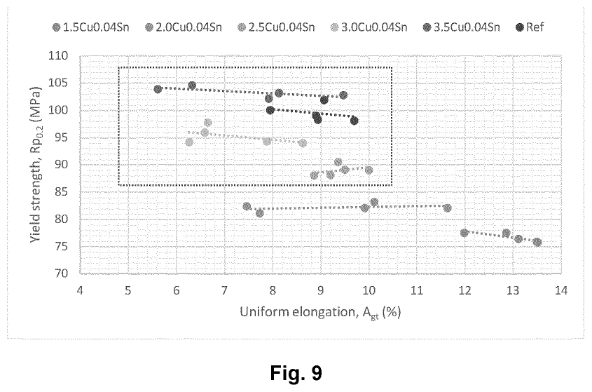

Increasing Cu content in the alloy also increased the tensile properties after long exposure at high temperature. Comparable properties after long exposure at high temperature as current commercial alloy AlSi7MgCu0.5 is achievable with minimum 3 wt. % Cu if T7 temper is applied as shown in FIG. 9.

TABLE 7

| Alloy Designation | Rp_{0.2} (MPa) | Rₘ (MPa) | Aₜ (%) |
|---|---|---|---|
| AlSi7Mg0.4Cu0.5 | 99 | 183 | 12.6 |
| (Ref) | | | |
| 1.5Cu0.04Sn | 77 | 168 | 16.48 |
| 2.0Cu0.04Sn | 82 | 176 | 9.94 |
| 2.5Cu0.04Sn | 89 | 191 | 9.76 |
| 3.0Cu0.04Sn | 95 | 199 | 7.39 |
| 3.5Cu0.04Sn | 103 | 215 | 7.66 |

EXAMPLE 4. Influence of Mq Addition

Two alloy variants without and with small addition of Mg listed in Table 8 were cast into permanent mould using similar casting method according to example 1 to investigate the effect of Mg addition on tensile properties. Uniaxial tensile testing at room temperature and after exposure at 250° C. for 500 hours were conducted with the method described in Example 2. Prior to the test, T7 temper (SHT 515oC 8 hours+WQ+AA 200° C. 8 hours) was applied to the alloy. Table 9 and Table 10 show the tensile properties at room temperature and following long exposure to 250° C. for 500 hours.

It can be clearly seen that the addition of Mg increased the tensile properties at room temperature. However, the strength is diminished following long exposure at high temperature., While room temperature tensile properties of an alloy without Mg (2.5Cu0.15Mn) was slightly lower than Mg containing alloy (2.5Cu0.15Mn0.1Mg), it displays better properties after exposure to high temperature.

TABLE 8

| Alloy | | | | | | | | | | |
|---|---|---|---|---|---|---|---|---|---|---|
| Designation | Si | Mg | Cu | Sn | Mn | Zr | Fe | Sr | Ti | Al |
| 2.5Cu0.15Mn | 7 | — | 2.5 | 0.04 | 0.15- | — | 0.12 | 0.015 | 0.08 | Rem |
| 2.5Cu0.15Mn0.1Mg | 7 | 0.1 | 2.5 | 0.04 | 0.15 | — | 0.12 | 0.015 | 0.08 | Rem |

TABLE 9

| Alloy Designation | Rp_{0.2} (MPa) | Rₘ (MPa) | Aₜ (%) |
|---|---|---|---|
| 2.5Cu0.15Mn | 233 | 302 | 3.7 |
| 2.5Cu0.15Mn0.1Mg | 256 | 331 | 4.7 |

TABLE 10

| Alloy Designation | Rp_{0.2} (MPa) | Rₘ (MPa) | Aₜ (%) |
|---|---|---|---|
| 2.5Cu0.15Mn | 120 | 220 | 8.8 |
| 2.5Cu0.15Mn0.1Mg | 96 | 196 | 8.8 |

EXAMPLE 5. T6 and T7 Properties Comparison

An 2.5Cu0.15Mn0.04Sn alloy with a composition listed in Table 8 was subjected to 10 different heat treatments prior to uniaxial tensile testing at room temperature. Table 11 shows the room temperature tensile properties of the alloy with the following heat treatment:

T6 : SHT 515° C. 8 hours+WQ+AA 200° C. 4 hours
T7 : SHT 515° C. 8 hours+WQ+AA 200° C. 8 hours

TABLE 11

| Alloy Designation | Temper | Rp_{0.2} (MPa) | Rₘ (MPa) | Aₜ (%) |
|---|---|---|---|---|
| 2.5Cu0.15Mn0.04Sn | T6 | 256 | 325 | 3.5 |
| 2.5Cu0.15Mn0.04Sn | T7 | 233 | 302 | 3.7 |

1. An aluminium alloy, comprising:
Mg: <0.25 wt. %, preferably 0.01-0.2 wt. %;
Si: 6-8 wt. %;
Cu: 2-4 wt. %;
Mn: <0.2 wt. %, preferably 0.01-0.1; more preferably 0.02-0.05 wt. %;
Fe: <0.2 wt. %;
Ti: 0.05-0.1 wt. %
Zn: <1 wt. %
Sn: 0.03-0.09, preferably 0.04-0.08 wt. %
Sr: <0.03 wt. %, preferably 0.001-0.03 wt. %
Zr: <0.2 wt. %
Hf: <0.5 wt. %
Cr: <0.3 wt. %
Mo: <0.3 wt. %
V: <0.3 wt. % W: <0.3 wt. % Nb: <0.3 wt. %,
the balance being aluminium and up to 0.05 wt. % unavoidable impurities.

2. The aluminium alloy as recited in claim 1, wherein the content of Sr is 0.005-0.03 wt. %, preferably 50 ppm-150 ppm.

3. The aluminium alloy as recited in claim 1, wherein the content of Zr is 0.02-0.2 wt. % and/or the content of Hf is 0.02-0.5 wt. %.

4. An aluminium casting made from the aluminium alloy of claim 1.

5. Method for producing the aluminium casting according to claim 4, comprising the steps
casting the alloy
Degassing to remove hydrogen in the melt
Adding grain refiner
Solution heat treatment to 490° C.-515° C. for 1 — 10 hours
Water quench
Ageing at 180° C.-240° C.

6. The method according to claim 5, wherein the ageing time is 2-8 hours, preferably 4-5 hours.
